(19) United States
(12) Patent Application Publication
(10) Pub. No.: US 2023/0162531 A1
(43) Pub. Date: May 25, 2023

(54) INTERPRETATION OF RESONANT SENSOR DATA USING MACHINE LEARNING

(71) Applicant: Microsoft Technology Licensing, LLC, Redmond, WA (US)

(72) Inventors: Jouya JADIDIAN, Los Gatos, CA (US); Rune Hartung JENSEN, Cupertino, CA (US); Ruben CABALLERO, San Jose, CA (US)

(73) Assignee: Microsoft Technology Licensing, LLC, Redmond, WA (US)

(21) Appl. No.: 17/456,103

(22) Filed: Nov. 22, 2021

(51) Int. Cl. G06V 40/16; G06V 10/80; G06V 10/778; G06F 3/01; G06T 13/40

(52) U.S. Cl. CPC G06V 40/176; G06V 10/806; G06V 10/7788; G06F 3/013; G06T 13/40

(57) ABSTRACT

Examples are disclosed relating to the tracking of facial expressions as computing device inputs. One example provides a computing system, comprising a logic system, and a storage system comprising instructions executable by the logic device to obtain facial tracking sensor data from one or more resonant inductive-capacitive (LC) sensors, determine a facial expression by inputting the facial tracking sensor data into a trained machine learning function, and output the facial expression determined.

### BACKGROUND

Wearable computing devices may track user gestures as a form of input. For example, hand gestures may be tracked via a depth camera, stereo cameras, and/or an inertial measurement unit (IMU) held by a user. For head mounted computing devices, head gestures may also be tracked via an IMU and/or image sensors.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

Examples are disclosed that relate to the tracking of facial expressions as computing device inputs. One example provides a computing system comprising a logic system, and a storage system comprising instructions executable by the logic device to obtain facial tracking sensor data from one or more resonant inductive-capacitive (LC) sensors, determine a facial expression by inputting the facial tracking sensor data into a trained machine learning function, and output the facial expression determined.

### BRIEF DESCRIPTION OF THE DRAWINGS

FIG. 1 shows an example facial expression sensing device worn by a user.

FIG. 2 shows an example frame for the sensing device of FIG. 1.

FIG. 3 shows a block diagram of an example sensing device.

FIG. 4 shows a block diagram of another example sensing device.

FIG. 5 shows a circuit diagram for an example resonant LC sensor.

FIG. 6A shows an example method for producing synthetic training data for a machine learning function.

FIG. 6B shows an example method for using a trained machine learning function to classify resonant LC sensor data.

FIG. 7A shows example virtual avatars providing facial expressions that can be mimicked to select an item from a graphical user interface menu.

FIG. 7B shows examples of virtual avatars illustrating a sequence of facial expressions for authenticating a user.

FIG. 8 shows graphical representations of example facial tracking sensor data output by a plurality of resonant LC sensors.

FIG. 9 shows a flow diagram illustrating an example method of using facial expressions as computing device inputs.

FIG. 10 shows a block diagram of an example computing system.

### DETAILED DESCRIPTION

Computing devices may be configured to identify facial gestures as user inputs. The use of facial gestures as inputs may provide various advantages over other input mechanisms. For example, in the context of a head mounted device (HMD), using peripheral devices such as a mouse or keyboard can be burdensome, and do not allow for hand-free use. Hand gestures (e.g. tracked using image data and/or IMU data from a handheld device) can be awkward in public or social settings, especially for users who are not sharing the same experience. Further, hand gestures may involve high energy expenditure and may be difficult for some users to perform, such as users with disabilities that impede hand and/or arm movement.

The use of facial gestures for computing device inputs may address such problems, but also may pose additional issues. For example, the use of eye blinks as user inputs may impede user vision when actively performing inputs. Likewise, eye gaze direction tracking can present difficulties in accurately determining intent, as a user's eyes can be easily distracted, and gaze cannot be tracked when a user is blinking. Further, cameras used for eye gaze tracking and blink tracking may suffer from occluded views of the eye due to placement (e.g. on a frame of a glasses-like device, which can place a camera at an oblique angle to the eye). The integration of cameras into a frame of a wearable device further may impact a visual design of the wearable device.

Accordingly, to avoid the use of cameras to track facial expressions, examples are disclosed that utilize resonant LC (inductive-capacitive) sensors to identify facial expressions, where each resonant LC sensor is configured to output a signal responsive to a position of a surface area proximate to the resonant LC sensor. Each resonant LC sensor comprises an antenna configured for near-field electromagnetic detection, and a resonant circuit that includes the antenna, an amplifier, and an oscillator. Each resonant LC sensor is operated by generating an oscillating signal on the antenna and detecting a near-field response of the resonant LC sensor at a selected frequency. A resonant frequency of the resonant LC circuit changes as a function of antenna proximity to a surface being sensed, thereby allowing changes in the position of the surface relative to the antenna to be sensed.

The disclosed examples also utilize a trained machine learning function to determine probable facial expressions from the resonant LC sensor outputs. The determined facial expressions then can be used as inputs for a computing system. The determined expressions can be used to control computing device functions, as well as to express emotions in communications to a receiving party via a displayed avatar.

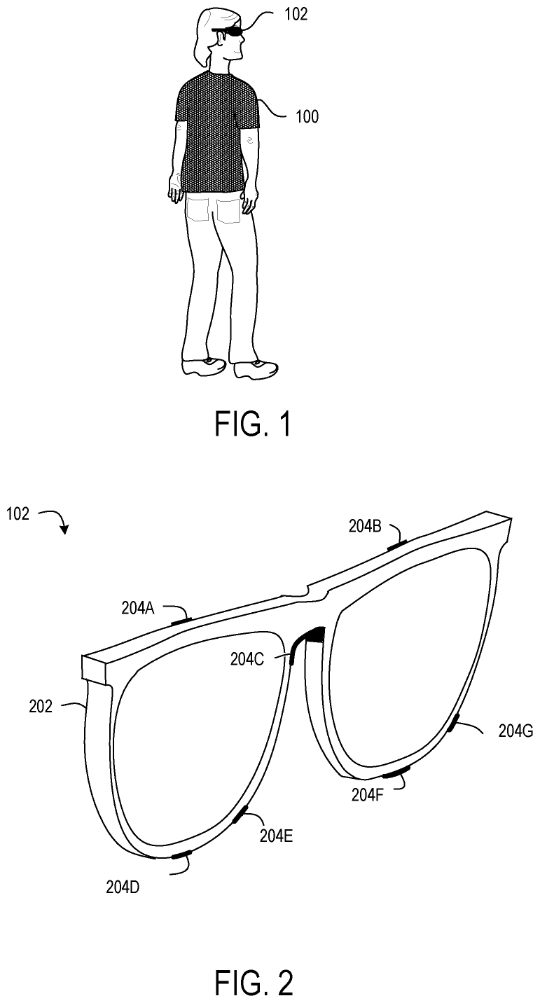

FIG. 1 illustrates a user 100 wearing an example sensing device 102 in the form of a head-mounted device (HMD) comprising resonant LC sensors for face tracking. As mentioned above, face tracking may be used to detect facial inputs made by facial expressions, which can include facial postures and/or gestures. The term “posture” refers to a particular static position of the face, e.g. smile, frown, raised eyebrows, and the term “gesture” refers to a movement of the face between different facial postures. Such inputs may be used to control the sensing device 102, to control another device in communication with the sensing device 102, to act as an emotive expression for sending to another device in a communication session, and/or to provide information regarding a user's state (e.g. a current emotional and/or comfort state). In some examples, HMD 100 may comprise a head-mounted display device configured to present augmented reality (e.g. mixed reality) imagery to a user. In other examples, HMD 100 may comprise facial tracking sensors but no displays, for example to remotely control another device.

FIG. 2 shows an example frame 202 suitable for use with sensing device 102. Frame 202 comprises a plurality of resonant LC sensors 204A-G spatially distributed on frame 202. Each sensor may be configured to sense a different portion of a face, such as a left eyebrow, right eyebrow, nose, left outer check, left inner check, right inner check, and right outer check. As explained in more detail below, each resonant LC sensor 204 is configured to output a signal that provides information regarding the position of the face proximate to the corresponding resonant LC sensor. The use of resonant LC sensors instead of cameras for facial tracking may allow for reduced size, weight, cost and/or power consumption for sensing device 102.

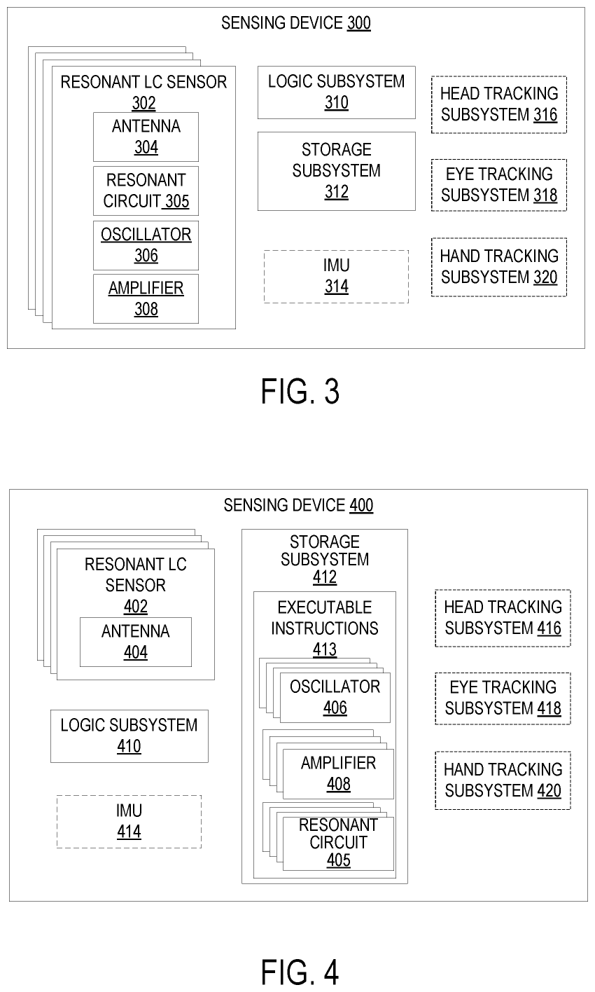

FIG. 3 shows a block diagram of an example sensing device 300. Sensing device 102 is an example of sensing device 300. In other examples, sensing device 300 may be configured to sense one or more surfaces other than on a face, whether on a human body or another object. Sensing device 300 comprises a plurality of resonant LC sensors 302 each configured to output a signal responsive to a position of a surface proximate to the corresponding resonant LC sensor. Each resonant LC sensor 302 comprises an antenna 304, a resonant circuit 305, an oscillator 306, and an amplifier 308. The resonant circuit 305 includes capacitance and/or inductance of antenna 304 combined with one or more other reactive components.

The antenna 304 is configured for near-field electromagnetic detection. In some examples antenna 304 may comprise a narrowband antenna with a quality factor in the range of 150 to 2000. The use of a such narrowband antenna may provide for greater sensitivity than an antenna with a lower quality factor. The oscillator 306 and amplifier 308 are configured to generate an oscillating signal on the antenna 304, and the antenna 304 detects a near-field response, which changes as a function of the position of the sensed surface relative to the antenna 304. In some examples, the oscillating signal is selected to be somewhat offset from a target resonant frequency of the resonant LC sensor (e.g. a resonant frequency that is often experienced during device use, such as a resonant frequency when a face is in a rest state), as such a configuration may provide for lower power operation than where the oscillating signal is more often at the resonant frequency of the resonant LC signal.

Sensing device 300 further comprises a logic subsystem 310 and a storage subsystem 312. In the HMD example, logic subsystem 310 may execute instructions stored in the storage system 312 to control each resonant LC sensor 302, and to determine facial tracking sensor data based upon signals received from each resonant LC sensor 302. Where sensing device 300 comprises an HMD, logic subsystem 310 may be configured to detect facial expressions (e.g. postures and/or gestures) using machine learning methods. For example, the instructions stored in the storage subsystem 312 may be configured to map sensor outputs to a facial gesture and/or posture using a trained machine learning function (e.g. a neural network) that is trained using labeled sensor data for each of a plurality of different facial gestures and/or postures for each of a plurality of users.

Sensing device 300 may further comprise an optional inertial measurement unit (IMU) 314 in some examples. IMU data from the IMU 314 may be used to detect changes in position of the sensing device, and may help to distinguish device movements (e.g. a device being adjusted on or removed from the head) from movements of the surface being sensed (e.g. facial movements).

Where sensing device 300 comprises an HMD, sensing device 300 may further optionally comprise a head tracking subsystem 316 that includes one or more head tracking cameras used to detect head gestures, an eye tracking subsystem 318 that includes one or more eye tracking cameras used to detect gaze directions, and/or a hand tracking subsystem 320 comprising one or more hand tracking cameras used to detect hand gestures. It will be understood that additional sensor subsystems (e.g. audio sensors, environmental sensors) and other potential HMD components (e.g. display device) may be included in sensing device 300. Head gestures, gaze directions, hand gestures, audio data, environmental data and/or other suitable data may be used in combination with facial tracking sensor data to supplement facial expressions to determine user intent and inputs.

FIG. 4 shows another example sensing device 400. Sensing device 400 comprises a plurality of resonant LC sensors 402 each comprising an antenna 404. The antenna 404 may be similarly configured as the antenna shown in FIG. 3. However, in contrast to sensing device 300, sensing device 400 comprises stored instructions 413 executable by the logic subsystem 410 to implement, for each resonant LC sensor 402, a resonant circuit 405, an oscillator 406, and an amplifier 408. Sensing device 400 may further comprise an optional IMU 414, as described above with regard to sensing device 300. Where sensing device 400 comprises an HMD, sensing device 400 may further optionally include head tracking subsystem 416, eye tracking subsystem 418, and hand tracking subsystem 420, similar to FIG. 3.

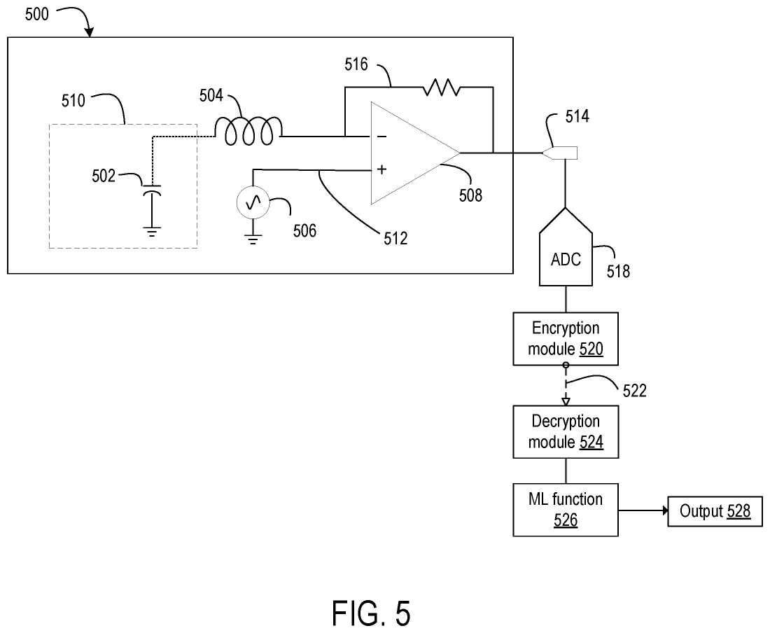

FIG. 5 shows a circuit diagram of an example resonant LC sensor 500. Resonant LC sensor 500 is an example of a resonant LC sensor of sensing device 300, for example. Resonant LC sensor 500 comprises an inductor 504, an oscillator 506, an amplifier 508, and an antenna 510, the antenna comprising a capacitance represented by capacitor 502. The oscillator 506 is configured to output a driven signal on node 512, and the amplifier 508 is configured to generate an oscillating signal in the antenna based upon the driven signal received at node 512 via feedback loop 516.

The capacitance 502 of the antenna 510 together with the inductor 504 form a series resonator. The capacitance of the antenna 510 is a function of a surface proximate to the antenna 510, and thus varies based on changes in a position of the surface proximate to the sensor. Changes in the capacitance at capacitor 502 changes the resonant frequency of the series resonator, which may be sensed as a change in one or more of a phase or an amplitude of a sensor output detected at output node 514. In some examples, a separate capacitor may be included to provide additional capacitance to the resonant circuit, for example, to tune the resonant circuit to a selected resonant frequency.

Signals output by resonant LC sensor 500 are converted to digital values by an analog-to-digital converter (ADC) 518. In some examples, data from the ADC 518 is processed locally (e.g. on an HMD), while in other examples, data from the ADC is processed remotely (e.g. by a cloud-based service at a data center of a cloud computing environment). In either instance, privacy of facial tracking data may be maintained by encrypting data from the ADC 518 via an encryption module 522 prior to sending the data to another device (local or remote) across a communications channel 522 for further processing.

In some examples, facial tracking sensor data may be encrypted after conversion to digital values, which can help to prevent hacking and preserve user data privacy. Facial tracking sensor data from a resonant LC sensor system may be relatively efficient to encrypt, as the information from each sensor is one-dimensional (e.g. a voltage signal or current signal), and a total number of sensors is relatively low. In contrast, image data from facial tracking systems that use cameras may utilize more resources to encrypt, due to a number of pixels per channel, plus a number of color channels in the case of color image data. The relatively low dimensionality of the facial tracking data may allow encryption to be efficiently performed at sample rates sufficient to track facial expressions in real time (e.g. 15-20 frames per second in some examples, and higher in other examples) without impacting power consumption as much as comparable facial tracking using image sensors.

Facial tracking data sent across communications channel 522 is decrypted by a decryption module 524, and then input into a trained machine learning function 526 for classification as a facial expression. In various examples, decryption module 524 and machine learning function 526 can be local to the device on which sensor 500 is located or remote from the device on which sensor 500 is located. Machine learning function 526 determines, for each facial expression recognized by the function, a probability that the input data represents that facial expression. From these probabilities, a determined facial expression is output at 528 for use as computing device input.

Machine learning function 526 can be trained using labeled resonant LC sensor data for each of a plurality of different facial expressions or each of a plurality of users. Machine learning function 526 can also be trained using other variables related to resonant LC sensing. For example, machine learning function 526 can be trained using labeled data representing the sensor worn at different locations on the face (e.g. high on the bridge of the nose as well as lower on the nose). This may help to improve performance across a wider range of faces, as different people may wear a head-mounted device differently on the face. Further, other types of sensor data also can be used to augment resonant LC facial sensor data, as described in more detail below.

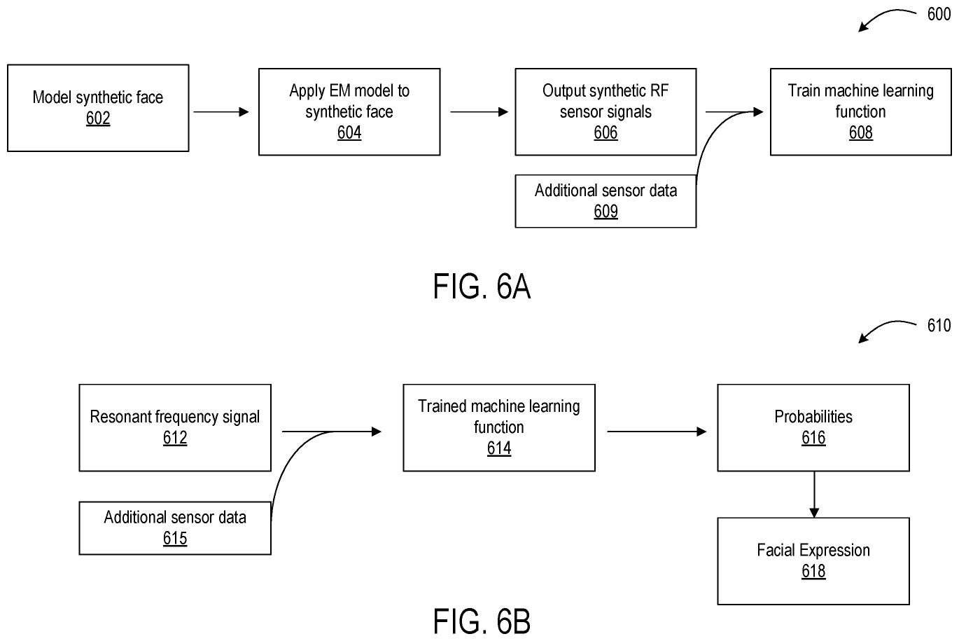

Obtaining labeled training data for training the machine learning function 526 may be a significant task, as it may involve taking many sensor readings for each of many users performing each of many expressions. As such, the generation of synthetic training data may allow for more efficient training than the use of physical training data. FIG. 6A schematically shows an example synthetic training method 600. Synthetic training method 600 comprises, at 602, modeling a synthetic face to represent facial expressions from a diverse population. Next, an electromagnetic model that models the electromagnetic properties of a facial tracking device comprising one or more resonant LC sensors is applied to the synthetic face at 604. The electromagnetic model models the circuit components of sensors, the signal applied to modeled sensors, and the position of the modeled sensors relative to the face, and outputs a set of synthetic resonant frequency (RF) sensor signals 606 for different facial expressions, wherein the synthetic RF signals simulate RF signals that would result from the facial expressions recreated by the synthetic face.

A machine learning function then may be trained with the synthetic data, as indicated at 608. Any suitable machine learning algorithms may be utilized by the trained machine learning function, including but not limited to expectation-maximization, k-nearest neighbor, extreme learning machine, neural networks such as recurrent neural networks, random forest, decision tree, recurrent neural networks, multiclass support vector machines, and convolutional long short-term memory (ConvLSTM). In the case of neural networks, any suitable neural net topology may be utilized. Likewise, any suitable training process may be used. For example, in the case of a neural network, a back propagation process may be used, along with any suitable loss function. Such a training process also may utilize some physical training data along with the synthetic data, wherein the term “physical training data” represents data acquired from a real sensor system worn by a real user.

As mentioned above, in some examples, additional sensor data 609, such as hand tracking, head tracking, gaze tracking, image, audio, IMU, and/or environmental data, may further be used as input to help train the machine learning function. The use of additional sensor data along with the resonant LC sensor data may help to provide context and/or filter noise, and thereby increase the accuracy of determined facial expressions. For example, IMU data may indicate that changes in facial tracking sensor signals are due to motion of the HMD from the user walking or moving their head, and not due to intentional facial expressions. As another example, eye tracking may help to continually provide a location of the center of a user's head, thereby providing an absolute distance from the HMD to the user's head that can be used to inform facial tracking sensor signals. In such examples, a machine learning function can be trained with such additional sensor data.

Where used, such data can be fused with the resonant LC sensor data prior to being input into the machine learning function using any suitable data fusion method. As an example, motion tracking data acquired via a camera (e.g. environmental tracking, hand tracking, or other) can be processed to identify motion, and data representing the identified motion can be concatenated with resonant LC sensor data for input into a machine learning function. Inertial motion data from an inertial measurement unit on a resonant LC sensor system likewise can be concatenated with RF sensor data for input into a machine learning function.

After training, the trained machine learning function can be used to classify facial tracking sensor data in a deployment phase. This is illustrated as method 610 in FIG. 6B. Method 610 comprises obtaining, at 612, signals from one or more resonant LC sensors. In some examples, the signals may be received in encrypted form, as described above, and then decrypted. The signals then are input into the trained machine learning function at 614. As described above, in some examples, facial tracking sensor data may be fused with additional sensor data, at 615, such as hand tracking, head tracking, gaze tracking, image, audio, IMU, and environmental data, to aid in classification.

Based upon the input data, the trained machine learning function outputs probabilities 616 that the input data represents each of a plurality of facial expressions that the function is trained to classify. As mentioned above, a facial expression can be a facial posture or gesture. In some examples, to identify facial gestures, temporal data from the resonant LC sensors (e.g. a plurality of sequential sensor data frames) can be input into the machine learning function. In other examples, individual frames can be input, and changes in facial postures output by the machine learning function over time can be used to recognize gestures. A facial expression with a highest probability may be selected as a determined facial expression for use as computing device input, at 618. In some examples, a confidence level may also be determined for the determined facial expression, and if the confidence level does not meet a confidence level threshold, then the result may be discarded. Further, in some examples, a temporal threshold may be applied to a facial posture to exclude micro expressions, which are expressions that appear spontaneously and briefly, and thus are not likely to represent an intended computing device input.

In some examples, facial expressions may have predetermined mappings to device functions. In some such examples, a computing device may be configured to receive an input of a user-defined mapping of a facial expression to a device function/control input. Allowing user-defined mappings may help to make the user experience more personalized. Further, user-defined mappings can be used to adapt control of the computing device to specific abilities of the user over time. Control inputs made by facial expressions also may be used to control other devices that are in communication with the sensing device, such as devices in a home or workplace environment. Such capabilities may provide a benefit to users with disabilities that inhibit other methods of making inputs.

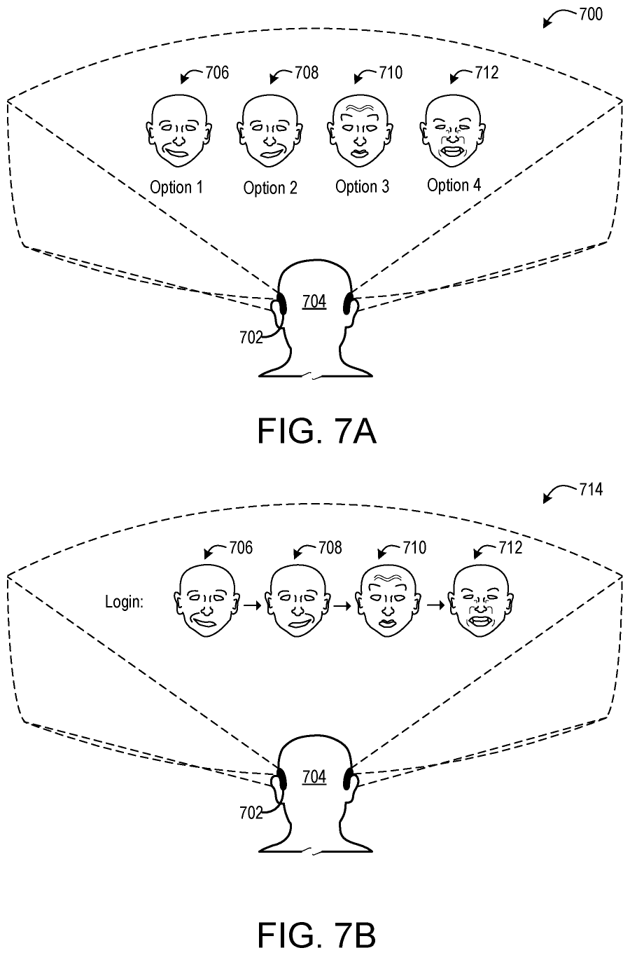

In some examples, a virtual avatar may be displayed to provide one or more of guidance and visual feedback to a user. FIG. 7A shows an example use scenario 700 in which head-mounted display device 702 worn by a user 704 is displaying a plurality of virtual avatars, each performing a different facial expression 706, 708, 710, 712 that may help guide the user 704 to mimic one or more of the facial expressions to trigger a selectable input to the HMD 702. It will be understood that the facial expressions 706, 708, 710 and 712 may be displayed as static images of facial postures, or animated as facial gestures. In one example, virtual avatar expressions 706, 708, 710, 712 may be shown together such as part of a displayed menu of selectable computing device functions. In such an example, a computing device function can be selected by performing the associated displayed facial expression. In another example, shown in FIG. 7B, virtual avatar expressions 706, 708, 710, 712 are being displayed as a sequence of facial expressions to be performed in order by the user to trigger a particular selectable input. Detecting performance of the sequence may indicate a high likelihood that the user 704 intends to trigger the associated selectable input.

In some examples, facial expressions may be used for user authentication. In some such examples, a virtual avatar may display one or more facial expressions, and a user may mimic the expression(s). Resonant LC sensor data can be classified to determine if the expression(s) are performed, and also compared to previously stored user data for the expression(s). If the sensor data does not match the illustrated expressions and/or does not match the previously stored sensor data for the user, then a device may remain locked. This may help to prevent potential unauthorized users from accessing the device.

Detected facial expressions also may be used in communication with others to express emotion. For example, a virtual avatar may be presented as performing the facial expressions of a first user for presentation to a second user at a remote device, such as during a communication session (e.g. a holographic communication session using an augmented reality HMD in which remote parties are represented by avatars). In such examples, information regarding a classification of a facial expression of the first user can be sent to the remote device as an emotive expression to display to the second user via an avatar representing the first user.

Where facial expressions are used for expressing emotion during a communications session, a computing device may be configured to recognize some facial expressions as emotive expressions for communicating to the recipient device, and to recognize other facial expressions as control expressions for controlling the local device. Such distinctions may be context-independent and persist in all use contexts, or determined based on a context of the computing device. As examples, the computing device may detect a facial expression as a control input if the facial expression occurs during a certain time period after a prompt for an input (e.g. within a certain time period after receipt of a notification), or if the user is performing a facial expression that matches one being performed by a virtual avatar intended to guide the user, as shown in FIG. 7. Such distinctions may also be determined based on other sensor data, such as gaze tracking data that indicates when a user notices or reacts to a notification. For expressions determined to be emotive expressions, the computing device may send the emotive expressions to the remote recipient device, and not send the control expressions to the remote recipient device.

In some examples, the computing device may further detect some facial expressions as neither control expressions nor emotive expressions, and neither send the facial expression to the recipient device nor use the facial expression as a control input. For example, the computing device may detect from additional context, such as image data, audio data, and/or environmental data, that a user may likely be making a facial expression because the user is distracted by something in their environment, such as communicating with someone else in the room or looking up at an object. Additional sensor data (e.g. temporal data indicating a duration of an expression) and/or historical user data may also provide context that indicates a facial expression is likely involuntary or otherwise unintentional (e.g. a micro expression or facial tic).

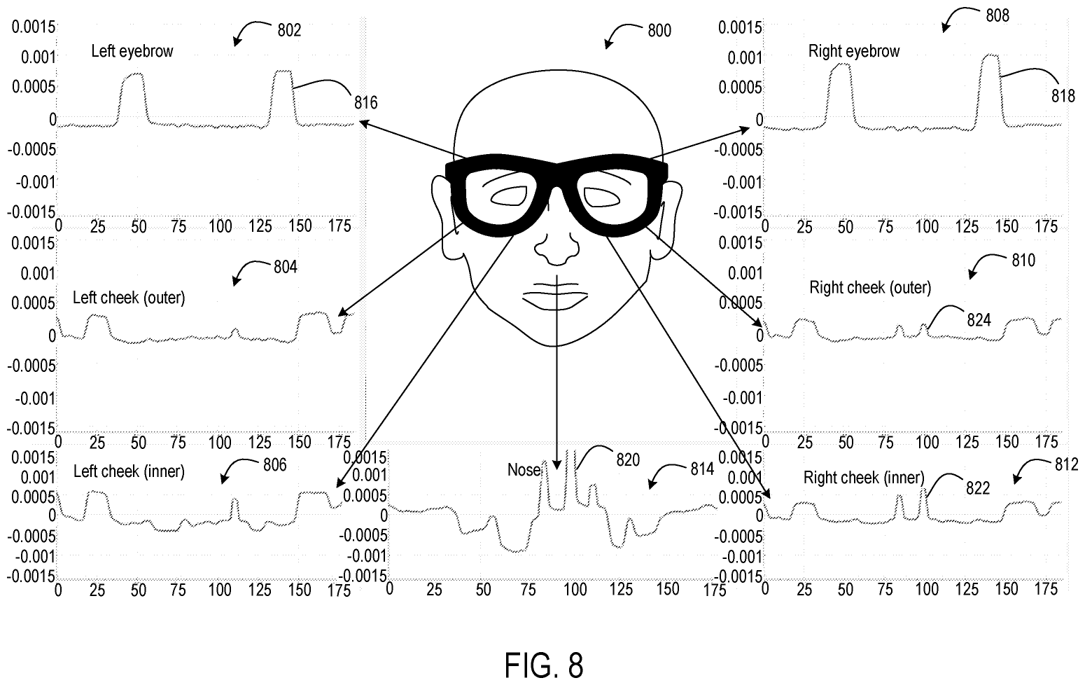

FIG. 8 shows example experimental facial tracking sensor data collected via resonant LC sensors on an HMD. A user wearing an HMD is schematically shown at 800. Each resonant LC sensor is configured to sense a different portion of the user's face. Example signals are depicted for left eyebrow (802), left outer cheek (804), left inner cheek (806), right eyebrow (808), right outer cheek (810), right inner cheek (812), and nose (814). Peaks and upticks in the signal waveforms represent detected movement of the user's face in those face regions. As examples, signal peaks shown at 816 for the left eyebrow and at 818 for the right eyebrow indicates where the user in this experiment raised both eyebrows. Signal peaks shown at 820 for the nose, 822 for the right inner cheek, and 824 for the right outer cheek indicates where the user smiled on the right side of the face.

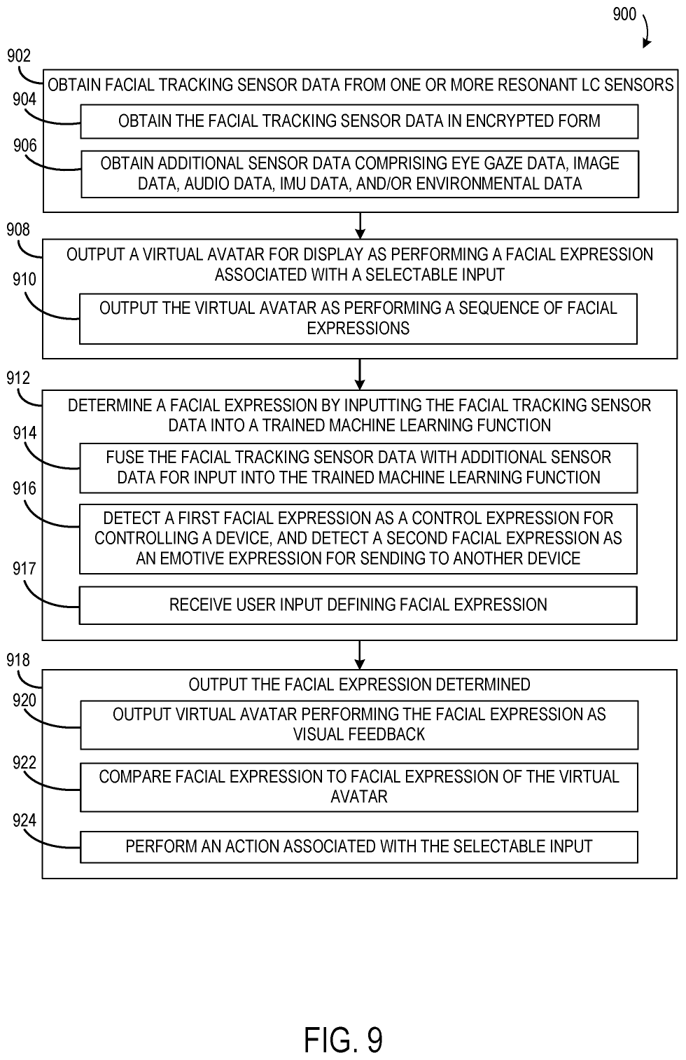

FIG. 9 shows a flow diagram illustrating an example method 900 of tracking and using facial expressions via a resonant LC sensor system. Method 900 may be performed on a sensing device as described herein, such as sensing devices 102, 300, and 400. In other examples, at least some processes of method 900 may performed by a remote computing device in communication with a sensing device, such as a cloud service. Method 900 includes, at 902, obtaining facial tracking sensor data from one or more resonant LC sensors. The facial tracking sensor data may be obtained in unencrypted form, or in encrypted form, as shown at 904. As mentioned above, digitized facial tracking sensor data from a resonant LC sensor may be relatively easy to encrypt due to the low dimensionality of the data. Method 900 further includes, at 906, receiving additional sensor data comprising one or more of eye gaze data, image data (e.g. RGB, infrared, depth image data), audio data, IMU data, or environmental data (e.g. ambient temperature, air pressure, humidity).

As mentioned above, in some examples, a virtual avatar may be presented as performing a facial expression for a user to mimic. Thus, method 900 may optionally include, at 908 outputting a virtual avatar for display as performing a facial expression associated with a selectable input. In some examples, the virtual avatar may be output as performing a sequence of facial expressions, at 910. The virtual avatar may be displayed via a display device, such as a see-through display device on an HMD.

The facial tracking sensor data and any additional sensor data may be sent to a recipient device for processing, where the recipient device can either be local or remote. For example, an HMD that detects the facial tracking and additional sensor data may process the data on the HMD itself, or may send the data to a remote computing device or cloud service for processing. Whether local or remote, method 900 includes, at 912, determining a facial expression that is being performed by the user by inputting the facial tracking sensor data into a trained machine learning function. The facial tracking sensor data may be decrypted prior to being input into the machine learning function, where the sensor data is obtained in encrypted form. As described above, the machine learning function may have been previously trained using labeled sensor data for each of a plurality of different facial expressions for a plurality of users. At 914, the facial tracking sensor data optionally may be fused with additional sensor data for input into the trained machine learning function. As mentioned above, the use of additional sensor data may provide context that helps to filter out noise from the facial tracking sensor data and increase an accuracy of the determined facial expression.

In some examples, determining a facial expression at 912 may include, at 916, detecting a first facial expression as a control expression for controlling a device, and detecting a second facial expression as an emotive expression for sending to another device (e.g. a recipient device of a communication session). As described above, emotive expressions may be sent to a recipient user to be presented by a virtual avatar (different from the virtual avatar at 908), while control expressions may be hidden from the recipient user to avoid confusion.

In some examples, a determined facial expression may be a user-defined expression intended to be associated with a particular input. Thus, method 900 optionally may comprise at 917, receiving an input of a user-defined mapping of a facial expression to a device function, such as during a mapping session for the computing device, or based on user request. User-defined mappings may allow the computing device to be highly adaptable and personalized to the user.

Method 900 further includes, at 918, outputting the facial expression determined, e.g. based upon probabilities output by the machine learning function. In some examples, outputting the facial expression optionally may include outputting, at 920, a virtual avatar performing the facial expression as visual feedback. Further, method 900 may optionally include, at 922, comparing the determined facial expression to the facial expression of the virtual avatar optionally output at 908 (which is a different avatar than the visual feedback avatar of 920, and may be displayed side-by-side with the avatar of 918 in some examples). If the likely facial expression matches that of the virtual avatar, then method 900 may include, at 924, performing an action associated with the selectable input.

In some embodiments, the methods and processes described herein may be tied to a computing system of one or more computing devices. In particular, such methods and processes may be implemented as a computer-application program or service, an application-programming interface (API), a library, and/or other computer-program product.

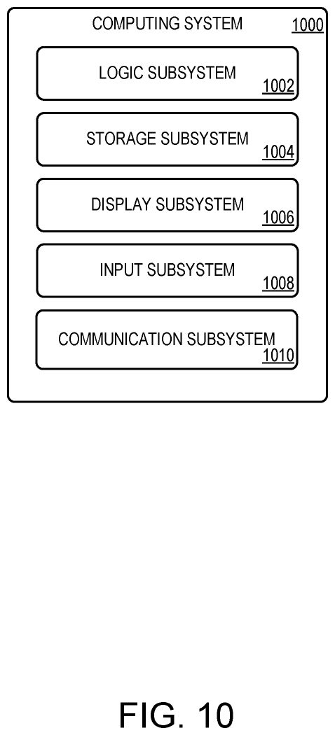

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), sensing devices 100, 300, and 400, and/or other computing devices.

Computing system 1000 includes a logic subsystem 1002 and a storage subsystem 1004. Computing system 1000 may optionally include a display subsystem 1006, input subsystem 1008, communication subsystem 1010, and/or other components not shown in FIG. 10.

Logic subsystem 1002 includes one or more physical devices configured to execute instructions. For example, logic subsystem 1002 may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Logic subsystem 1002 may include one or more processors configured to execute software instructions. Additionally or alternatively, logic subsystem 1002 may include one or more hardware or firmware logic machines configured to execute hardware or firmware instructions. Processors of logic subsystem 1002 may be single-core or multi-core, and the instructions executed thereon may be configured for sequential, parallel, and/or distributed processing. Individual components of logic subsystem 1002 optionally may be distributed among two or more separate devices, which may be remotely located and/or configured for coordinated processing. Aspects of logic subsystem 1002 may be virtualized and executed by remotely accessible, networked computing devices configured in a cloud-computing configuration.

Storage subsystem 1004 includes one or more physical devices configured to hold instructions executable by the logic machine to implement the methods and processes described herein. When such methods and processes are implemented, the state of storage subsystem 1004 may be transformed—e.g., to hold different data.

Storage subsystem 1004 may include removable and/or built-in devices. Storage subsystem 1004 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1004 may include volatile, nonvolatile, dynamic, static, read/write, read-only, random-access, sequential-access, location-addressable, file-addressable, and/or content-addressable devices.

It will be appreciated that storage subsystem 1004 includes one or more physical devices. However, aspects of the instructions described herein alternatively may be propagated by a communication medium (e.g., an electromagnetic signal, an optical signal, etc.) that is not held by a physical device for a finite duration.

Aspects of logic subsystem 1002 and storage subsystem 1004 may be integrated together into one or more hardware-logic components. Such hardware-logic components may include field-programmable gate arrays (FPGAs), program- and application-specific integrated circuits (PASIC ASICs), program- and application-specific standard products (PSSP/ASSPs), system-on-a-chip (SOC), and complex programmable logic devices (CPLDs), for example.

The term “module” may be used to describe an aspect of computing system 1000 typically implemented in software by a processor to perform a particular function using portions of volatile memory, which function involves transformative processing that specially configures the processor to perform the function. Thus, a module, program, or engine may be instantiated via logic processor 1002 executing instructions held by non-volatile storage device 1006, using portions of volatile memory 1004. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The term “module” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1006 may be used to present a visual representation of data held by storage subsystem 1004. This visual representation may take the form of a graphical user interface (GUI). As the herein described methods and processes change the data held by the storage subsystem 1004, and thus transform the state of the storage machine, the state of display subsystem 1006 may likewise be transformed to visually represent changes in the underlying data. Display subsystem 1006 may include one or more display devices utilizing virtually any type of technology. Such display devices may be combined with logic subsystem 1002 and/or storage subsystem 1002 in a shared enclosure, or such display devices may be peripheral display devices.

When included, input subsystem 1008 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1010 may be configured to communicatively couple computing system 1000 with one or more other computing devices. Communication subsystem 1010 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1000 to send and/or receive messages to and/or from other devices via a network such as the Internet.

Another example provides a computing system, comprising a logic system, and a storage system comprising instructions executable by the logic device to obtain facial tracking sensor data from one or more resonant inductive-capacitive (LC) sensors, determine a facial expression by inputting the facial tracking sensor data into a trained machine learning function, and output the facial expression determined. The facial expression may additionally or alternatively include one or more of a facial gesture and a facial posture. The instructions may be additionally or alternatively executable to output a virtual avatar for display via a display device as performing the facial expression as visual feedback. The instructions may be additionally or alternatively executable to detect a first facial expression as a control expression for controlling a device, and to detect a second facial expression as an emotive expression for sending to another device in a communication session. The instructions may be additionally or alternatively executable to receive additional sensor data comprising one or more of eye gaze data, image data, audio data, IMU data, or environmental data, and to fuse the facial tracking sensor data with the additional sensor data for input into the trained machine learning function. The instructions may be additionally or alternatively executable to obtain the facial tracking sensor data in encrypted form. The computing system may additionally or alternatively include a display device and the one or more resonant LC sensors. The instructions may be additionally or alternatively executable to receive an input of a user-defined mapping of a facial expression to a device function.

Another example provides a method enacted on a computing device, the method comprising outputting a virtual avatar for display via a display device as performing a facial expression associated with a selectable input, obtaining facial tracking sensor data from one or more resonant inductive-capacitive (LC) sensors, determining a facial expression by inputting the facial tracking sensor data into a machine learning function, comparing the facial expression to the facial expression of the virtual avatar, and based at least upon comparing the facial expression to the facial expression of the virtual avatar, perform an action associated with the selectable input. The facial expression may additionally or alternatively include one or more of a facial gesture and a facial posture. The method may additionally or alternatively include outputting the virtual avatar as performing a sequence of facial expressions, determining based on the sensor data a sequence of facial expressions, detecting the sequence of facial expressions as matching the sequence of facial expressions of the virtual avatar, and performing an output associated with the sequence of facial expressions. The method may additionally or alternatively include comparing the facial expression to a previously stored facial expression in an authentication process. Where the facial expression is a first facial expression and comprises a control expression, the method may additionally or alternatively include determining a second facial expression from the facial tracking sensor data, the second facial expression comprising an emotive expression to send to another device in a communication session. The method may additionally or alternatively include receiving additional sensor data comprising one or more of eye gaze data, image data, audio data, IMU data, and environmental data, and wherein the instructions are executable to fuse the facial tracking sensor data with the additional sensor data for input into the machine learning function. The method may additionally or alternatively include receiving an input of a user-defined mapping of a facial expression to a device function.

Another example provides a head-mounted device comprising a frame, one or more resonant LC sensors each positioned on the frame to sense motion of a corresponding portion of a human face, a logic system, and a storage system comprising instructions executable by the logic system to receive facial tracking sensor data from the one or more resonant LC sensors, convert the facial tracking sensor data from analog to digital values, encrypt the facial tracking sensor data, and send the facial tracking sensor data to a recipient device. The recipient device may additionally or alternatively include a device local to the head-mounted device. The instructions may be additionally or alternatively executable to decrypt the facial tracking sensor data, and input the facial tracking sensor data into a machine learning function. The recipient device may additionally or alternatively include a remote device. The head-mounted device may additionally or alternatively include a display, and the instructions may be additionally or alternatively executable to display a virtual avatar for as performing a facial expression based at least on the facial tracking sensor data as visual feedback.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system, comprising:
a logic system; and
a storage system comprising instructions executable by the logic device to obtain facial tracking sensor data from one or more resonant inductive-capacitive (LC) sensors,
determine a facial expression by inputting the facial tracking sensor data into a trained machine learning function, and
output the facial expression determined.

2. The computing system of claim 1, wherein the facial expression comprises one or more of a facial gesture and a facial posture.

3. The computing system of claim 1, wherein the instructions are further executable to output a virtual avatar for display via a display device as performing the facial expression as visual feedback.

4. The computing system of claim 1, wherein the instructions are executable to detect a first facial expression as a control expression for controlling a device, and to detect a second facial expression as an emotive expression for sending to another device in a communication session.

5. The computing system of claim 1, wherein the instructions are further executable to receive additional sensor data comprising one or more of eye gaze data, image data, audio data, IMU data, or environmental data, and to fuse the facial tracking sensor data with the additional sensor data for input into the trained machine learning function.

6. The computing system of claim 1, wherein the instructions are executable to obtain the facial tracking sensor data in encrypted form.

7. The computing system of claim 1, further comprising a display device and the one or more resonant LC sensors.

8. The computing system of claim 1, wherein the instructions are executable to receive an input of a user-defined mapping of a facial expression to a device function.

9. A method enacted on a computing device, the method comprising:
outputting a virtual avatar for display via a display device as performing a facial expression associated with a selectable input,
obtaining facial tracking sensor data from one or more resonant inductive-capacitive (LC) sensors,
determining a facial expression by inputting the facial tracking sensor data into a machine learning function,
comparing the facial expression to the facial expression of the virtual avatar, and
based at least upon comparing the facial expression to the facial expression of the virtual avatar, perform an action associated with the selectable input.

10. The method of claim 9, wherein the facial expression comprises one or more of a facial gesture and a facial posture.

11. The method of claim 9, further comprising outputting the virtual avatar as performing a sequence of facial expressions, determining based on the sensor data a sequence of facial expressions, detecting the sequence of facial expressions as matching the sequence of facial expressions of the virtual avatar, and performing an output associated with the sequence of facial expressions.

12. The method of claim 9, further comprising comparing the facial expression to a previously stored facial expression in an authentication process.

13. The method of claim 9, wherein the facial expression is a first facial expression and comprises a control expression, and further comprising determining a second facial expression from the facial tracking sensor data, the second facial expression comprising an emotive expression to send to another device in a communication session.

14. The method of claim 9, further comprising receiving additional sensor data comprising one or more of eye gaze data, image data, audio data, IMU data, and environmental data, and wherein the instructions are executable to fuse the facial tracking sensor data with the additional sensor data for input into the machine learning function.

15. The method of claim 9, further comprising receiving an input of a user-defined mapping of a facial expression to a device function.

16. A head-mounted device comprising:
a frame;
one or more resonant LC sensors each positioned on the frame to sense motion of a corresponding portion of a human face;
a logic system; and
a storage system comprising instructions executable by the logic system to
receive facial tracking sensor data from the one or more resonant LC sensors,
convert the facial tracking sensor data from analog to digital values,
encrypt the facial tracking sensor data, and
send the facial tracking sensor data to a recipient device.

17. The head-mounted device of claim 16, wherein the recipient device comprises a device local to the head-mounted device.

18. The head-mounted device of claim 17, wherein the instructions are further executable to decrypt the facial tracking sensor data, and input the facial tracking sensor data into a machine learning function.

19. The head-mounted device of claim 16, wherein the recipient device comprises a remote device.

20. The head-mounted device of claim 16, further comprising a display, and wherein the instructions are executable to display a virtual avatar for as performing a facial expression based at least on the facial tracking sensor data as visual feedback.
